(19) United States
(12) Patent Application Publication
(10) Pub. No.: US 2005/0116890 A1
(43) Pub. Date: Jun. 2, 2005

(54) Plasma display panel driving apparatus and driving method thereof

(75) Inventors: Dong-Young Lee, Suwon-si (KR); Kazuhiro Ito, Suwon-si (KR); Joo-Yul Lee, Suwon-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 10/968,914

(22) Filed: Oct. 21, 2004

(30) Foreign Application Priority Data
Oct. 24, 2003 (KR) 10-2003-0074669

(51) Int. Cl. G09G 3/28

(52) U.S. Cl. 345/60

(57) ABSTRACT

A plasma display panel driving apparatus is disclosed. The apparatus may include a first switch coupled between a first power source for supplying a first voltage and a first node; a second switch coupled between a second power source for supplying a second voltage and the first node; a capacitor, for charging a fourth voltage corresponding to a difference between a third voltage and the first voltage, of which a cathode is coupled to the first node; a third switch coupled between an anode of the capacitor and a second node that is coupled to a first electrode of the panel capacitor; and a fourth switch coupled between the first node and the second node.

### CROSS REFERENCE TO RELATED APPLICATIONS

This application claims priority to Korea Patent Application No. 10-2003-0074669 filed on Oct. 24, 2003 in the Korean Intellectual Property Office, the entire disclosure of which is herein incorporated by reference in its entirety.

### BACKGROUND OF THE INVENTION

1. Field of the Invention

The present invention relates to a plasma display panel (PDP) driving apparatus and a driving method thereof.

2. Description of the Related Art

Among flat panel displays, plasma display panels (PDP) offer the highest brightness and emission efficiency, and the widest viewing angle. The plasma display panel is a flat display device that displays characters or images using plasma created by gas discharge. Depending on the size of the PDP, several tens to several millions of pixels may be arranged in a matrix format on the PDP.

Construction of a conventional PDP is described with reference to FIG. 1 and FIG. 2. FIG. 1 is a partial perspective view of a plasma display panel, and FIG. 2 shows an arrangement of electrodes in the PDP.

As shown in FIG. 1, the PDP includes two glass substrates 1 and 6, which are arranged in a face to-face relationship. On the first substrate 1, pairs of a scan electrode 4 and a sustain electrode 5 which are covered with a dielectric layer 2 and a protective layer 3 are arranged in parallel. On the second substrate 6, a plurality of address electrodes 8, which are covered with an insulating layer 7, are arranged. Barrier ribs 9 are formed in parallel with the address electrodes 8 on the insulating layer 7. A fluorescent material 10 is formed on the surface of the insulating layer 7 and on both sides of the barrier ribs 9. The glass substrates 1 and 6 are arranged in a face-to-face relationship with a discharge space 11 formed therebetween, such that the scan electrodes 4 and the sustain electrodes 5 lie in a direction perpendicular to the address electrodes 8. The discharge spaces 11 at intersections of the address electrodes 8 and the pairs of scan electrode 4 and sustain electrode 5 forms discharge cells 12.

As shown in FIG. 2, the PDP has a pixel matrix in an M×N matrix format. For example, a plurality of address electrodes A₁ to Aₘ are arranged in a column direction, and a plurality of scan electrodes Y₁ to Yₙ and a plurality of sustain electrodes X₁ to Xₙ are alternately arranged in a row direction.

In operation, one frame is divided into a plurality of subfields, and driven by a is driving circuit. Scales of gray may be expressed by different combinations of the subfields, each comprised of a reset period, an address period, and a sustain period.

Illustratively, the reset period is a period for erasing wall charges that have been formed by a previous sustain discharge, and setting up a new wall charge in order to stably perform a next address discharge. The address period is a period for selecting cells being turned on and cells being turned off, and accumulating a wall charge on cells being turned on (addressed cell). The sustain period is a period for performing a sustain discharge to display a video image on an addressed cell.

Illustratively, “wall charge” means a charge that is formed on a wall close to each electrode of the discharge cell and is accumulated on the electrode. The wall charge is described as being “formed” or “accumulated” on the electrode, although the wall charge do not actually contact the electrodes. Further, “wall voltage” means a potential difference formed on the wall of the discharge cell by the wall charge.

An address operation of the PDP is performed by operation of a scan integrated circuit (IC) and an address IC, which include a plurality of selection circuits including two serially coupled switches. Further, the output of the scan selection circuit corresponds to the scan electrode (Y electrode) and the output of the address selection circuit corresponds to the address electrode. Generally, one driver IC includes a plurality of selection circuits, however, hereinafter one driver IC is understood to include one selection circuit for convenience.

A highly efficient plasma display panel may be created by increasing the ratio of Xe in discharge gases. This improves emission efficiency and brightness. However, increasing the ratio of Xe increases the driving voltage. As a result, a high voltage difference between the scan electrode Y and the sustain electrode X is required to create a reset discharge during the reset period.

Thus, a conventional method such as that disclosed in Japanese Patent Publication No. H7-134565 discloses that voltage and width of a first sustain discharge pulse V_{fr} next to an address period are set to be larger than the voltage and width of another sustain discharge pulse Vₛ, so that the sustain discharge is stably performed after address discharge. FIG. 3 shows a driving waveform according to one such conventional method.

However, according to conventional driving methods, a separate power source is required to increase the voltage of the first sustain discharge pulse. Additionally, current may flow backward from the power source supplying the first sustain discharge voltage to the power source that supplies the sustain discharge voltage Vₛ. In addition, manufacturing costs increase because an expensive switch capable of withstanding high voltage is required to endure a conventional high voltage Vₚᵣ.

### SUMMARY OF THE INVENTION

The present invention provides a plasma display panel driving apparatus capable of both increasing a first sustain discharge voltage and preventing a current from flowing backward. Another embodiment of the invention provides a plasma display panel driving apparatus that increases a first sustain discharge voltage by using a switch having a low withstand voltage instead of using a separate power source. Also provided is a simple driving circuit for driving a switch with a low withstand voltage.

A plasma display panel driving apparatus according to one aspect of the present invention applies a voltage to a panel capacitor coupled between a first electrode and a second electrode and may include a first switch, a second switch, a capacitor, a third switch, and a fourth switch. The first switch may be coupled between a first power source supplying a first voltage and a first node. The second switch may be coupled between a second power source supplying a second voltage and the first node. The capacitor may have a cathode coupled to the first node, and may charge a fourth voltage that corresponds to a difference between a third voltage and the first voltage. The third switch may be coupled between an anode of the capacitor and a second node that is coupled to a first electrode of the panel capacitor. The fourth switch may be coupled between the first node and the second node.

In this embodiment, the anode of the capacitor may be coupled to a third power source that supplies the fourth voltage, and the fourth voltage may be charged at the capacitor when the second switch is turned on.

A first diode may be further included for cutting off a current flowing from the anode of the capacitor to the third power source. The first diode may be coupled between the third power source and the anode of the capacitor.

The third switch may be a transistor having a body diode. A second diode may be further coupled between the anode of the capacitor and the second node to decouple a current path caused by the body diode.

The fourth switch may be a transistor having a body diode. Illustratively, the anode of the body diode may be coupled to the first node.

It is preferable that the third voltage is higher than the first voltage.

In one embodiment, a sustain discharge pulse applied to the first electrode in a sustain period is divided into a plurality of groups according to a pulse waveform. The third voltage is at least one sustain discharge pulse voltage of a first group (among the plurality of groups) that includes the first sustain discharge pulse applied to the first electrode after an address period. The first voltage may be another sustain discharge pulse voltage of any other group but the first group.

In one exemplary embodiment, the first voltage is applied to the first electrode through a path that includes the first switch, the first node, the fourth switch, and the second node. The third voltage is applied to the first electrode through a path that includes the first power source, the first node, the capacitor, the third switch, and the second node.

The second voltage may be applied to the first electrode when the sustain discharge pulse is applied to the second electrode, through a path that includes the second node, the fourth switch, the first node, and the second switch.

The third switch may be turned off when the first voltage is charged at the first electrode, and the fourth switch may be turned off when the third voltage is applied to the first electrode.

A plasma display panel driving apparatus according to another aspect of the present invention applies a voltage to a panel capacitor coupled between a first electrode and a second electrode. The PDP driving apparatus may include a first power source, a capacitor, and a first switch. The first power source may supply a first voltage, and a capacitor may be coupled between a first node and a second node to charge a third voltage that corresponds to a difference between a second voltage and the first voltage. The first switch may be coupled between the second node and a third node that is coupled to the first electrode. In one embodiment, when the first power source is coupled to the first node and the first node is coupled to the third node, the first voltage is applied to the first electrode. When the first node and the third node are decoupled, the first power source is coupled to the first node, the first switch is turned on, and the second voltage is applied to the first electrode. In this embodiment, the first switch is turned off when the first voltage is charged at the first electrode.

A second switch may be further coupled between the first node and the third node. When the second switch is turned on, the first node couples to the third node, and when the second switch is turned off, the first node decouples from the third node.

A third switch may be further coupled between the first power source and the first node. When third switch is turned on, the first power source couples to the first node.

A method of driving a plasma display panel according to another aspect of the present invention drives a plasma display panel that applies a voltage to a panel capacitor coupled between a first electrode and a second electrode. In the method, a sustain discharge pulse of a first voltage, a second voltage, and a sustain discharge pulse of a third voltage that is lower than the first voltage are each applied to the first electrode during a sustain period. The first voltage is applied to the first electrode by using a power source that supplies the third voltage and a capacitor that charges a voltage corresponding to a difference between the first voltage and the third voltage.

In this embodiment, a first switch is coupled between the power source and the capacitor, a second switch is coupled between the capacitor and the first electrode, and a third switch is coupled between the first switch and the first electrode. The first voltage may be applied to the first electrode through a first path which is formed by turning on the first and the second switches. The third voltage may be applied to the first electrode through a second path which is formed by turning on the first and the third switches.

Thus, the second path is decoupled by turning off the third switch when the first voltage is applied to the first electrode; and the first path is decoupled by turning off the second switch when the third voltage is applied to the first electrode.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 is a partial perspective view of a conventional plasma display panel.

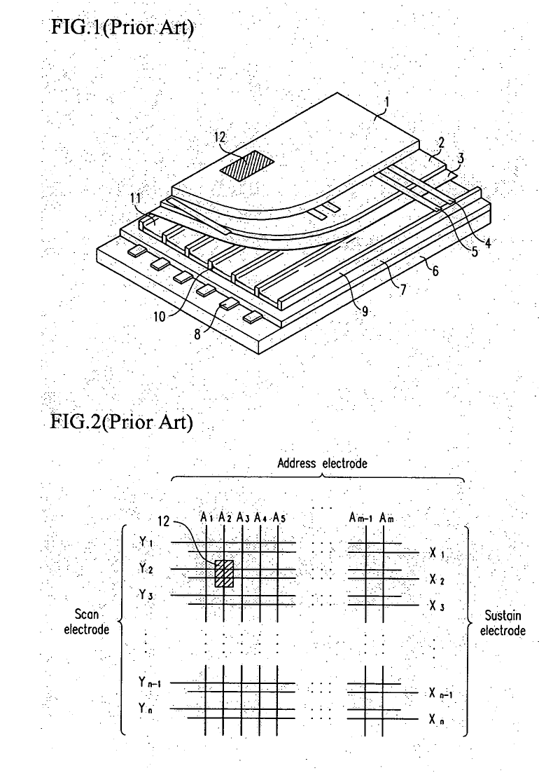

FIG. 2 shows an arrangement of electrodes in a conventional plasma display panel.

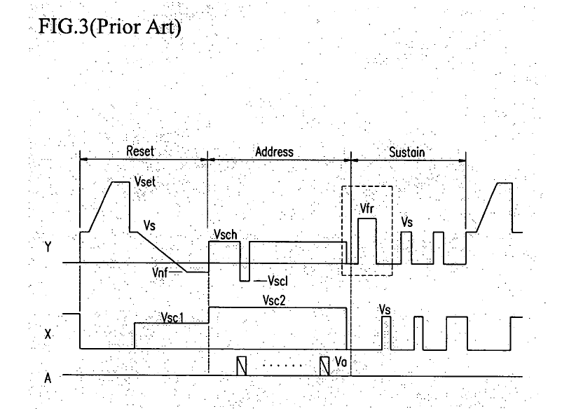

FIG. 3 shows a driving waveform of a plasma display panel according to one conventional method.

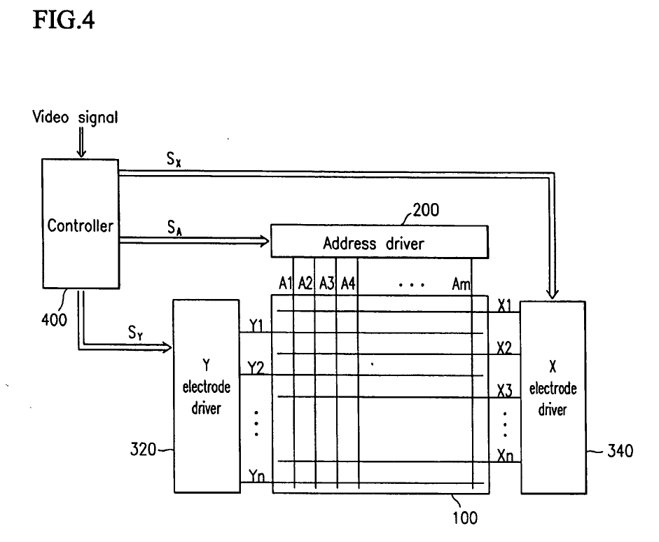

FIG. 4 shows a plasma display panel according to an exemplary embodiment of the present invention.

FIG. 5 is a detailed circuit diagram of a Y electrode driver according to a first exemplary embodiment of the present invention.

FIGS. 6A, 6B, and 6C show current paths of a Y electrode driver in a sustain period according to a first exemplary embodiment of the present invention.

FIG. 7 is a detailed circuit diagram of a Y electrode driver according to a second exemplary embodiment of the present invention.

FIGS. 8A, 8B, and to 8C show current paths of a Y electrode driver in a sustain period according to a second exemplary embodiment of the present invention.

FIG. 9 shows a Vₚᵣ driver and a switch driving circuit according to a first exemplary embodiment.

FIG. 10 shows a Vₚᵣ driver and a switch driving circuit according to a second exemplary embodiment.

### DETAILED DESCRIPTION OF THE PREFERRED EMBODIMENTS

In the following detailed description, the preferred embodiments of the invention are shown and described, by way of illustrating the best modes contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

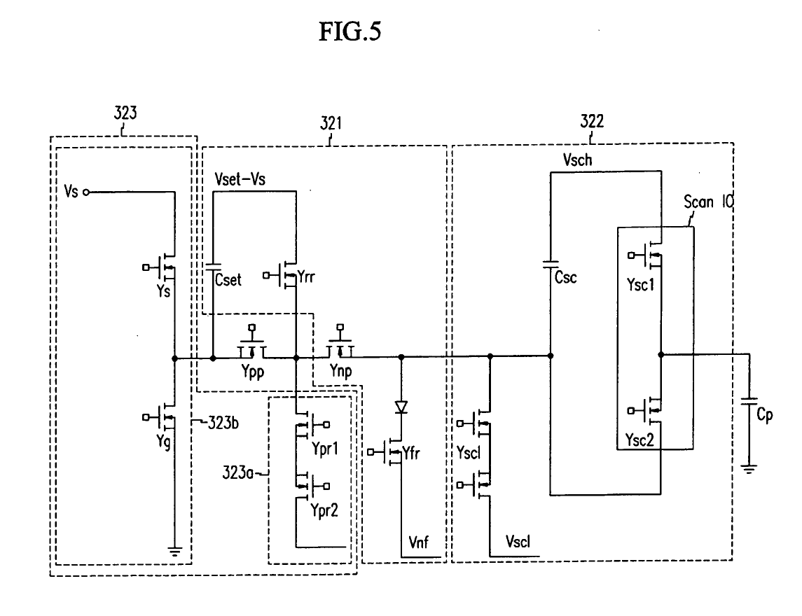

First, a plasma display panel according to an exemplary embodiment of the present invention is described in detail with reference to FIG. 4.

FIG. 4 shows a plasma display panel configured according to an exemplary embodiment of the present invention. As shown, the plasma display panel device may include a plasma display panel 100, an address driver 200, a Y electrode driver 320, an X electrode driver 340, and a controller 400. The plasma display panel 100 includes a plurality of address electrodes A₁ to Aₘ extended in the row direction and a plurality of pairs of first electrodes (hereinafter “Y electrodes”) Y₁ to Yₙ and a second electrodes (hereinafter “X electrodes”) X₁ to Xₙ extended in the column direction.

In use, the address driver 200 receives an address driving control signal SA from is the controller 400, and applies a data signal for display to each address electrode A₁ to Aₘ to select a discharge cell that is to be displayed.

The Y electrode driver 320 receives a Y electrode driving signal SY from the controller 400 and applies the data signal to the Y electrode. The X electrode driver 340 receives an X electrode driving signal SX from the controller 400, and applies the data signal to the X electrode.

The controller 400 receives a video signal externally, and generates the address driving control signal SA, the Y electrode driving signal SY, and the X electrode driving signal SX, and transfers each signal to the address driver 200, the Y electrode driver 320, and the X electrode driver 340, respectively.

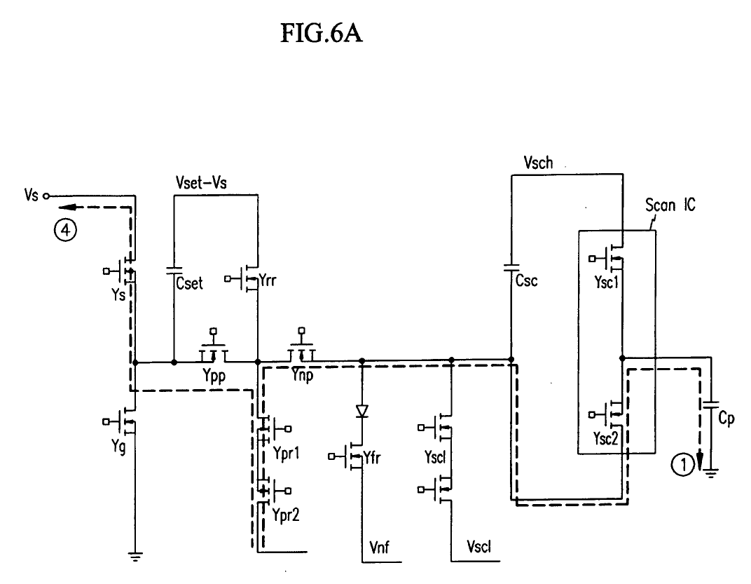

FIG. 5 is a detailed circuit diagram of a Y electrode driver 320 according to a first exemplary embodiment of the present invention. As shown, the Y electrode driver 320 may include a reset driver 321, a scan driver 322, and a sustain driver 323. The reset driver for generating a reset waveform in the reset period may include a capacitor Cₛₑₜ being operated as a floating power source, ramp switches Yᵣᵣ and Y_{fr}, a diode D_{f}, and a switch Yₙₚ for preventing a reverse current coupled in a main path.

The scan driver 322 for generating a scan pulse in the address period may include a capacitor C_{sc}, a switch Y_{sc1}, and a scan driver including switches Y_{sc}1 and Y_{sc}2.

The sustain driver 323 for generating a sustain discharge pulse in the sustain period includes a Vₚᵣ driver 323a that produces a first sustain discharge pulse, and a Vₛ driver 323b that produces a second or later sustain discharge pulse.

Further, a switch Yₚₚ is coupled in the main path to supply the sustain discharge is pulse to a panel capacitor Cₚ. Thus, the panel capacitor Cₚ equivalently shows capacitance between the X electrode and the Y electrode. Further, although the X electrode of the panel capacitor Cₚ is coupled to the ground end for convenience, the X electrode may be coupled to the X electrode driver 340.

The Vₚᵣ driver 323a, which is coupled to a power source Vₚᵣ that supplies the first sustain discharge voltage, may include a switch Yₚᵣ. The Vₛ driver 323b, which is coupled to a power source Vₛ, may include switches Yₛ and Y_{g}. In one embodiment, the switch Yₚᵣ includes two transistors Yₚᵣ1 and Yₚᵣ2 for enduring high voltage, which are coupled according to a back-to-back method. Further, the Vₚᵣ driver 321 may be separated from the Vₛ driver 323a by the switch Yₚₚ.

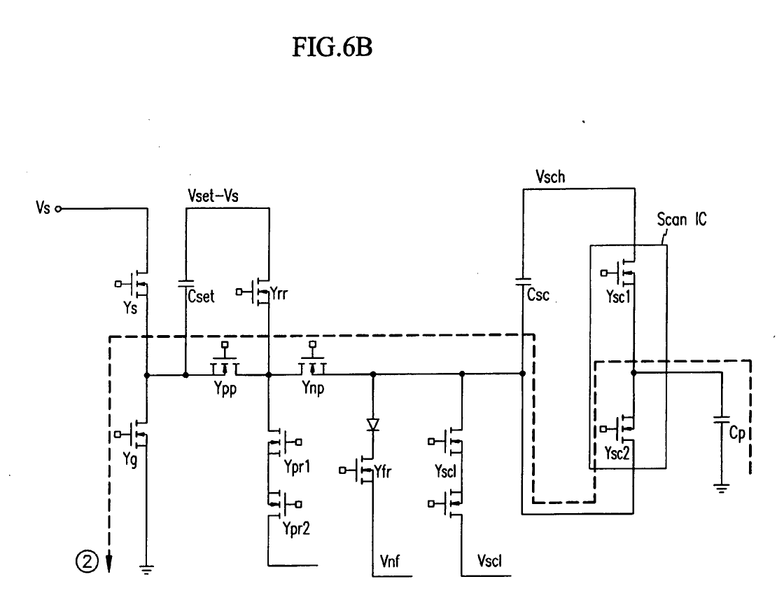

The process in which the sustain discharge pulse is applied to the panel capacitor Cₚ in the Y electrode driver 320 is described with reference to FIGS. 6A, 6B, and 6C.

FIGS. 6A, 6B, and 6C show current paths of a Y electrode driver 320 in a sustain period according to a first exemplary embodiment of the present invention.

First, when the switch Yₚₚ is turned off and the switches Yₙₚ and Yₚᵣ are turned on, the voltage Vₚᵣ, the first sustain discharge pulse, charges at the panel capacitor Cₚ through a path consisting of a body diode to the panel capacitor Cₚ. That is, the path may include: the power source Vₚᵣ, the switch Yₚᵣ₂, the switch Yₚᵣ₁, the switch Yₙₚ , and the switch Y_{sc2} (path 1 in FIG. 6A).

Further, when the switch Ypr is turned off, and the switches Yₚₚ , Y_{g}, and Y_{sc2} are turned on, the voltage charged at the panel capacitor Cₚ discharges through the following path: the panel capacitor Cₚ, the switch Y_{sc2}, the switch Yₙₚ, the switch Yₚₚ, the switch Y_{g}, and the ground end (path 2 in FIG. 6B).

Next, when the switches Yₛ, Yₙₚ, and Yₚₚ are turned on, the voltage Vₛ charges at the panel capacitor Cₚ through a path that includes: the power source Vₛ, the switch Yₛ, the switch Yₚₚ, the switch Yₙₚ, the switch Y_{sc2}, and the panel capacitor Cₚ (path 3 in FIG. 6C).

Further, when the switch Yₚᵣ is turned off, and the switches Yₚₚ , Y_{g}, and Y_{sc2} are turned on, the voltage charged at the panel capacitor Cₚ discharges through the path that includes the panel capacitor Cₚ, the switch Y_{sc2}, the switch Yₙₚ, the switch Yₚₚ, the switch Y_{g}, and the ground end (path 2 in FIG. 6B).

Then, the process in which the voltage charges at the panel capacitor Cp through the path 3 in FIG. 6C and in which the voltage charged at the panel capacitor Cp discharges through the path 2 FIG. 6B, is repeated.

Meanwhile, when the voltage Vₚᵣ is charged at the panel capacitor Cₚ through the path 1 in FIG. 6A by the plasma display panel driver, current can flow backward from the power source Vₚᵣ to the power source Vₛ through the path 4, because the potential of the voltage Vₚᵣ is higher than the potential of the voltage Vₛ.

Thus, the plasma display panel driver according to the first exemplary embodiment of the present invention may be separated into the Vₚᵣ driver 323a and the Vₛ driver 323b by the switch Vₚₚ; and the plasma display panel driver can prevent current from flowing backward from the power source Vₚᵣ to the power source Vₛ through the path 4 by turning off the switch Vₚₚ when the voltage Vₚᵣ is charged at the panel capacitor via the path 1 shown in FIG. 6A.

Because the voltage Vₚᵣ is higher than the sustain discharge voltage Vₛ, conventional PDPs use an expensive switch that can withstand high voltages as the switch Yₚᵣ. They also use a high voltage power source, separate from the sustain discharge voltage Vₛ, to supply the voltage Vₚᵣ.

In an opposite manner, the second exemplary embodiment of the present invention provides a plasma display panel driver that supplies the high voltage Vₚᵣ using the capacitor, the low voltage power source, and a switch with a low withstand voltage.

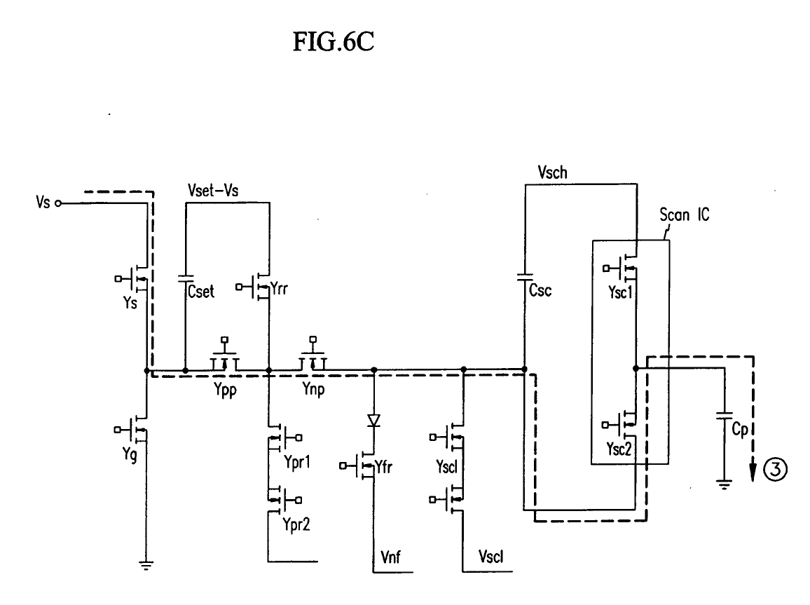

FIG. 7 shows a Y electrode driver including a Vₚᵣ driver 323c according to the second exemplary embodiment of the present invention. A reset driver is expressed with only a power source Vₛₑₜ and a switch Yₙₚ, and a scan driver is not described for convenience.

As shown in FIG. 7, the Vₚᵣ driver 323c according to the second exemplary embodiment of the present invention includes a capacitor Cₚᵣ, a switch Yₚᵣ, and diodes D₁ and D₂. Here, the diode D₂ can prevent current flowing to a power source Vₚᵣ-Vₛ, and the diode D₁ can cut off the current caused by the body diode of the switch Yₚᵣ.

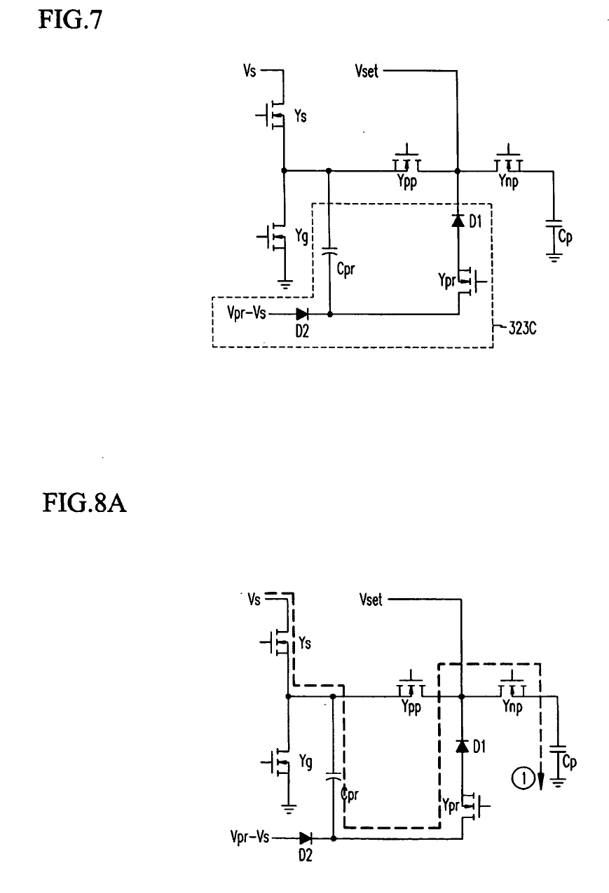

Next, the process in which the sustain discharge pulse is applied to the panel capacitor Cₚ in the Y electrode driver is described with reference to FIGS. 8A, 8B, and 8C.

FIGS. 8A, 8B, and 8C show current paths of a Y electrode driver in a sustain period according to a second exemplary embodiment of the present invention.

First, before a sustain discharge pulse is applied to the Y electrode in the sustain period, switches Y_{g}, Yₚₚ and Yₙₚ are turned on, and switches Ypr and Ys are turned off, so the voltage of the Y electrode is maintained at 0V. Thus, the potential of a first end of the capacitor Cₚᵣ is 0V. A voltage Vₚᵣ-Vₛ is supplied to a second end of the capacitor Cₚᵣ through the power source Vₚᵣ-Vₛ-diode D₂ and the voltage Vₚᵣ-Vs is charged at the capacitor Cₚᵣ.

Then, when the switch Yₚₚ is turned off and the switches Yₛ, Yₙₚ, and Yₚᵣ are turned on, the voltage charges at the panel capacitor Cₚ through a path that includes the power source Vₛ- the switch Yₛ- the capacitor Cₚᵣ- the switch Yₚᵣ- the diode D₁- the switch Yₙₚ- the panel capacitor Cₚ (path 1 in FIG. 8A). At this time, the voltage Vₛ is supplied to a first end of the capacitor Cₚᵣ and the voltage Vₚᵣ-Vₛ charges at the capacitor Cₚᵣ. In this manner, the voltage Vₚᵣ which is the sum of the voltage Vₛ and the voltage Vₚᵣ-Vₛ, charges at the panel capacitor Cₚ.

Next, when the switches Yₛ and Yₚᵣ are turned off and the switches Yₚₚ, Yₙₚ, and Y_{g} are turned on, the voltage charged at the panel capacitor Cₚ is discharged through a path that includes of the panel capacitor Cₚ- the switch Yₙₚ- the switch Y_{g}- the ground end (path 2 in FIG. 8B).

Then, when the switches Yₛ and Yₙₚ are turned on, the voltage Vₛ is charged at the panel capacitor Cₚ through a path that includes of the power source Vₛ- the switch Yₛ- the switch Yₚₚ- the switch Yₙₚ- the panel capacitor Cₚ (path 3 in FIG. 8C). Further, the panel capacitor Cₚ discharges through the path 2 in FIG. 8B.

In the same manner, the process in which the voltage is charged at the panel capacitor Cₚ through path 3 in FIG. 8C and the voltage charged at the panel capacitor Cₚ is discharged through path 2 in FIG. 8B is repeated.

As such, according to the second exemplary embodiment of the present invention, the Yₚᵣ driver 323a and the switches with high withstand voltage Yₚᵣ₁ and Yₚᵣ₂ can be substituted for the switch with low withstand voltage Yₚᵣ and the diode D₁ by using the low voltage power source and the capacitor. The second exemplary embodiment of the present invention can improve efficiency and reduce the cost.

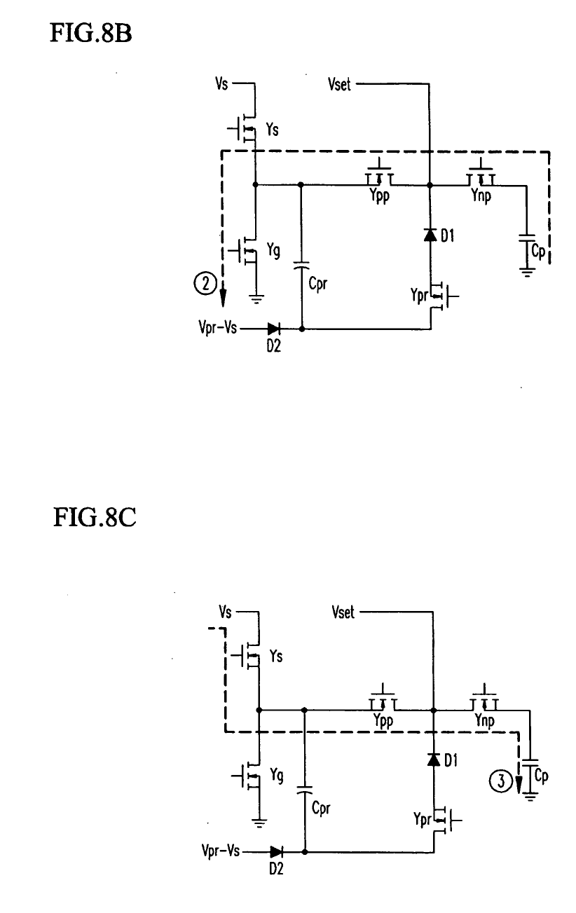

Meanwhile, FIG. 9 shows a driving circuit for driving the switches with high withstands voltage Yₚᵣ₁ and Yₚᵣ₂ in the Vₚᵣ driver 323a and the Yₚᵣ driver 323b according to another exemplary embodiment of the present invention. As shown in FIG. 9, the switches with high withstand voltage Yₚᵣ₁ and Yₚᵣ₂ used in the Vₚᵣ driver 323a are driven by turning on/off the transistors Q₁ and Q₂. The transistors Q₁ and Q₂ are turned on/off by using a push-pull circuit, and the power source V₂ and the transistors Q₁ and Q₂ are coupled to the gate control power source V₁. Here, the power source V₂ is a bias power source of the transistors Q₁ and Q₂.

However, the Vₚᵣ driver 323c according to the second exemplary embodiment of the present invention can simplify the switch driving circuit by using the switch with low withstand voltage Yₚᵣ.

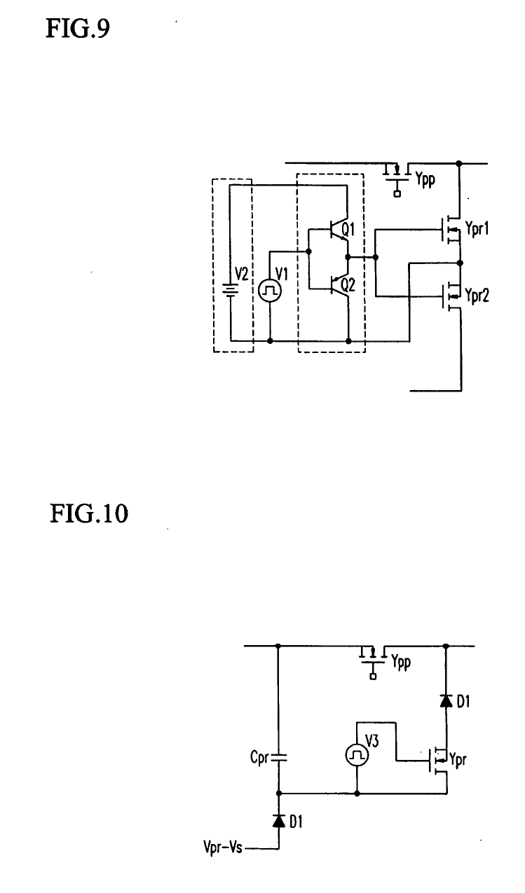

FIG. 10 shows a driving circuit for driving a switch having a low withstand voltage Yₚᵣ in the Vₚᵣ driver 323c according to the second exemplary embodiment of the present invention.

As shown in FIG. 10, the driving circuit for driving the switch with low withstand voltage Yₚᵣ in the Vₚᵣ driver 323c can drive the switch Yₚᵣ by directly coupling the switch Yₚᵣ to the gate control power source V3 without using the push-pull circuit.

Further, the power source Vₚᵣ-Vₛ, about 50 V being coupled to the capacitor Cₚᵣ in the Vₚᵣ driver 323c according to the second exemplary embodiment may be a small voltage source such as the power source V_{cc}, about 17V for driving the switch and the power source Va, about 75V for applying the address voltage etc. which has been used in the conventional driving circuits. The small voltage source may be directly used or may be raised by a booster circuit. Thus, any separate power source does not need to be used as is required in conventional PDPs.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, according to the present invention, a circuit for applying a first high voltage sustain discharge pulse in a sustain period may be separated by using a main pass switch from a circuit that applies a second or later sustain discharge pulse. Thus, the reverse current from the power source Vₚᵣ to the power source Vₛ can be prevented.

Further, a high voltage power source and a switch with high withstand voltage can be substituted for a low voltage power source and a switch with low withstand voltage by direct coupling a capacitor to a power source supplying a sustain discharge power source. The difference voltage between a first sustain discharge voltage and a second or later discharge voltages is charged at the capacitor. Thus, the efficiency can be improved and the cost can be reduced. At this time, the power sources V_{cc} and Vₐ etc., which have been used in the conventional driving circuit can be used as the low voltage power source. Therefore, a separate power source is not required.

Further, a switch driving circuit can be simplified by using a switch with a low withstand voltage.

1. A plasma display panel driving apparatus having a panel capacitor coupled between a first electrode and a second electrode, comprising:
a first switch which is coupled between a first power source configured to supply a first voltage and a first node;
a second switch which is coupled between a second power source supplying a second voltage and the first node;
a capacitor of which a cathode is coupled to the first node, for charging a fourth voltage corresponding to a difference between a third voltage and the first voltage;
a third switch which is coupled between an anode of the capacitor and a second node which is coupled to a first electrode of the panel capacitor; and
a fourth switch which is coupled between the first node and the second node.

2. The plasma display panel driving apparatus of claim 1, wherein the anode of the capacitor is coupled to a third power source configured to supply the fourth voltage, and the fourth voltage is charged at the capacitor when the second switch is turned on.

3. The plasma display panel driving apparatus of claim 2, further comprising a first diode which is coupled between the third power source and the anode of the capacitor, for cutting off a current flowing from the anode of the capacitor to the third power source.

4. The plasma display panel driving apparatus of claim 1, wherein the third switch is a transistor having a body diode, and wherein a second diode is further coupled between the anode of the capacitor and the second node to decouple a current path caused by the body diode.

5. The plasma display panel driving apparatus of claim 1, wherein the fourth switch is a transistor having a body diode, and wherein the anode of the body diode is coupled to the first node.

6. The plasma display panel driving apparatus of claim 1, wherein the third voltage is higher than the first voltage.

7. The plasma display panel driving apparatus of claim 1, wherein a sustain discharge pulse applied to the first electrode in a sustain period is divided into a plurality of groups according to a pulse waveform;
wherein the third voltage is at least one sustain discharge pulse voltage of a first group among the plurality of groups, comprising the first sustain discharge pulse applied to the first electrode after an address period; and
the first voltage is another sustain discharge pulse voltage of other groups excluding the first group.

8. The plasma display panel driving apparatus of claim 7, wherein the first voltage is applied to the first electrode through a path consisting of the first switch, the first node, the fourth switch, and the second node; and
wherein the third voltage is applied to the first electrode through a path consisting of the first power source, the first node, the capacitor, the third switch, and the second node.

9. The plasma display panel driving apparatus of claim 8, wherein the second voltage is applied to the first electrode when the sustain discharge pulse is applied to the second electrode; and
wherein the second voltage is applied to the first electrode through a path consisting of the second node, the fourth switch, the first node, and the second switch.

10. The plasma display panel driving apparatus of claim 8, wherein the third switch is turned off when the first voltage is charged at the first electrode; and the fourth switch is turned off when the third voltage is applied to the first electrode.

11. A plasma display panel driving apparatus having a panel capacitor coupled between a first electrode and a second electrode, comprising:
a first power source for supplying a first voltage;
a capacitor coupled between a first node and a second node, for charging a third voltage corresponding to a difference between a second voltage and the first voltage; and
a first switch coupled between the second node and a third node, the third node coupled to the first electrode,
wherein when the first power source is coupled to the first node and the first node is coupled to the third node, the first voltage is applied to the first electrode, and
when the first node and the third node are decoupled, the first power source is coupled to the first node, and the first switch is turned on, the second voltage is applied to the first electrode.

12. The plasma display panel driving apparatus of claim 11, wherein the first switch is turned off when the first voltage is charged at the first electrode.

13. The plasma display panel driving apparatus of claim 11, wherein a second switch is coupled between the first node and the third node; and
when the second switch is turned on, the first node is coupled to the third node, and when the second switch is turned off, the first node is decoupled from the third node.

14. The plasma display panel driving apparatus of claim 11, wherein a third switch is coupled between the first power source and the first node; and
when third switch is turned on, the first power source is coupled to the first node.

15. The plasma display panel driving apparatus of claim 11, wherein the second voltage is higher than the first voltage.

16. The plasma display panel driving apparatus of claim 11, wherein a sustain discharge pulse being applied to the first electrode in a sustain period is divided into a plurality of groups according to a pulse waveform;
the second voltage is at least one sustain discharge pulse voltage of a first group among plurality of groups, comprising the first sustain discharge pulse being applied to the first electrode after address period; and
the first voltage is another sustain discharge pulse voltage of other groups excluding the first group.

17. A method of driving a plasma display panel having a panel capacitor coupled between a first electrode and a second electrode, comprising, in a sustain period:
applying a sustain discharge pulse of a first voltage to the first electrode;
applying a second voltage to the first electrode; and
applying a sustain discharge pulse of a third voltage that is lower than the first voltage to the first electrode,
wherein the first voltage is applied to the first electrode by using a power source supplying the third voltage and a capacitor for charging a voltage corresponding to a difference between the first voltage and the third voltage.

18. The driving method of claim 17, wherein the sustain discharge pulse being applied to the first electrode in a sustain period is divided into a plurality of groups according to a pulse waveform;
wherein the first voltage is at least one sustain discharge pulse voltage of a first group among a plurality of groups, comprising the first sustain discharge pulse being applied to the first electrode after address period; and
wherein the third voltage is another sustain discharge pulse voltage of other groups excluding the first group.

19. The driving method of claim 17, further comprising: coupling a first switch is coupled between the power source and the capacitor; coupling a second switch between the capacitor and the first electrode; and
applying the first voltage to the first electrode through a first path which is formed by turning on the first and the second switches.

20. The driving method of claim 19, further comprising: coupling a third switch is coupled between the first switch and the first electrode; and
applying the third voltage to the first electrode through a second path which is formed by turning on the first and the third switches.

21. The driving method of claim 20, further comprising: decoupling wherein the second path by turning off the third switch, when the first voltage is applied to the first electrode; and
the first path decoupling by turning off the second switch, when the third voltage is applied to the first electrode.
